(19) United States
(12) Patent Application Publication
(10) Pub. No.: US 2012/0314072 A1
(43) Pub. Date: Dec. 13, 2012

(54) IMAGE GENERATION APPARATUS

(75) Inventors: Kouei KIYO, Kobe-shi (JP); Yasuyoshi SAWADA, Kobe-shi (JP); Satoshi HARUMOTO, Kobe-shi (JP); Yoshitsugu YAMASHITA, Kobe-shi (JP)

(73) Assignee: FUJITSU TEN LIMITED, Kobe-shi (JP)

(21) Appl. No.: 13/486,576

(22) Filed: Jun. 1, 2012

(30) Foreign Application Priority Data
Jun. 8, 2011 (JP) 2011-127928

(51) Int. Cl. H04N 7/18

(52) U.S. Cl. 348/148; 348/E07.085

(57) ABSTRACT

A shift determining part of an image display system determines a traveling direction of a vehicle. A composite image generator generates a composite image that shows a periphery of the vehicle and an area that is in a direction opposite to the determined traveling direction of the vehicle in a seamless manner. The periphery is viewed from a virtual viewpoint that is set looking down at the vehicle. A display displays a display image including the composite image. Since the display image includes the composite image that shows the area that is in the direction opposite to the determined traveling direction of the vehicle, a user can notice an object that exists in the direction opposite to the traveling direction of the vehicle by looking at the display image.

### BACKGROUND OF THE INVENTION

1. Field of the Invention

The invention relates to an image display technology for an in-vehicle display apparatus.

2. Description of the Background Art

Conventionally, known is an image display system that displays an image that shows the periphery of a vehicle on an in-vehicle display based on the shot images acquired by a camera that is installed in the vehicle such as a car. A user (typically a driver) can view the periphery of the vehicle in almost real time by using this image display system.

In an example, when the vehicle runs backward, the image display system that displays the backward image showing the area behind the vehicle is useful for the user to grasp the object that exists in the area behind the vehicle. Thus, the user can drive backward safely while preventing the vehicle from having a collision with the object.

These days, also known is another image display system that shows the downward view that is viewed from a virtual viewpoint looking down at a vehicle and that is generated based on shot images acquired by a plurality of cameras that capture images of the periphery of the vehicle in different directions. A user can easily understand the location of an object that exists near the vehicle by checking on such a downward view.

A user uses such an image display system when rather great attention is needed, such as when the user parks a vehicle at a parking area, or when the vehicle passes close by another vehicle on a narrow street. In such a case where rather great attention is needed, the user pays most of his or her attention to the traveling direction of the vehicle. Thus, even when there is an object, such as a vehicle or a pedestrian, which is coming closer from the direction opposite to the traveling direction of the vehicle, the user might not notice the object coming closer. Therefore, a new technology allowing a user to notice the object that exists in the direction opposite to the traveling direction of a vehicle has been required.

Also known is another image display system that is capable of switching images for display between the area in front of a vehicle and the area behind the vehicle. Such an image display system generally displays a forward image that shows the area in front of the vehicle when the traveling direction of the vehicle is the forward direction (that is, when the shift lever is set at a position except “P” and “R”), and displays a backward image that shows the area behind the vehicle when the traveling direction of the vehicle is the backward direction (that is, when the shift lever is set at “R”). However, in some cases such as when the user parks the vehicle, even when the traveling direction of the vehicle is the backward direction, the user needs to check the area in front of the vehicle. Therefore, new image display systems have been under development. One of the new image display systems displays a forward image in response to user's operation, even when the traveling direction of the vehicle is the backward direction. However, displaying the forward image when the traveling direction is the backward direction may mislead the user into believing the traveling direction of the vehicle is the forward direction. Therefore, the new image display system has been in need of more improvement.

### SUMMARY OF THE INVENTION

According to one aspect of the invention, an image generation apparatus is used in a vehicle, and generates an image that shows a periphery of the vehicle. The image generation apparatus includes an input that acquires shot images from a plurality of cameras, each of which captures the periphery of the vehicle in a different direction, a controller that determines a traveling direction of the vehicle, a generator that generates a composite image including a first area and a second area in a seamless manner based on the shot images, the first area showing the periphery of the vehicle viewed from a virtual viewpoint that is set looking down at the vehicle, the second area showing an area that includes an outside of the first area and is in a direction opposite to the determined traveling direction, and an output that transmits a display image including the composite image to a display apparatus to display the display image on the display apparatus.

Since the display image includes the composite image showing the second area that is in the direction opposite to the determined traveling direction of the vehicle, a user can check an object that exists in the direction opposite to the determined traveling direction of the vehicle by looking at the display image. Moreover, since the composite image shows, in a seamless manner, the first area showing the periphery of the vehicle and the second area that is in the direction opposite to the traveling direction, the user can immediately understand the location of the object that exists in the direction opposite to the determined traveling direction of the vehicle.

According to another aspect of the invention, an image generation apparatus is used in a vehicle and generates an image that shows a periphery of the vehicle. The image generation apparatus includes an input that acquires shot images from a plurality of cameras, each of which captures one of an area in front of the vehicle and an area behind the vehicle, a controller that determines a traveling direction of the vehicle, a generator that generates a display image based on the shot images, and an output that transmits the display image to a display apparatus to display the display image on the display apparatus. The generator generates as the display image a first display image that shows the area in front of the vehicle when the determined traveling direction of the vehicle is a forward direction, and selectively one of a second display image and a third display image in conformity with a user's operation when the determined traveling direction of the vehicle is a backward direction. The second display image shows the area behind the vehicle, and the third display image shows the area in front of the vehicle in a different form than the first display image.

Each of the first display image for display when the determined traveling direction of the vehicle is the forward direction and the third display image for display when the determined traveling direction of the vehicle is the backward direction shows the area in front of the vehicle in a different form. This prevents the user from mistaking the traveling direction of the vehicle.

According to another aspect of the invention, an image generation apparatus is used in a vehicle and generates an image that shows a periphery of the vehicle. The image generation apparatus includes an input that acquires a shot image from a side camera that captures a side area of the vehicle, a controller that determines a traveling direction of the vehicle, a detector that detects a state of a side mirror of the vehicle, a generator that generates a display image that shows the side area covering the determined traveling direction of the vehicle based on the shot image acquired from the side camera when the side mirror is retracted, and an output that transmits the display image to a display apparatus to display the display image on the display apparatus.

When the side mirror is retracted, the display image that shows the side area and covers the determined traveling direction of the vehicle is displayed. Thus, when the side surface of the vehicle is close to an object, a user can check the side state of the vehicle.

Therefore, the first object of the invention is for a user to be able to notice an object that exists in a direction opposite to a traveling direction of a vehicle.

The second object of the invention is to prevent the user from mistaking the traveling direction of the vehicle.

The third object of the invention is for the user to be able to check a side state of the vehicle when a side surface of the vehicle is close to an object.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 shows a configuration of an image display system of the first embodiment.

FIG. 2 shows the locations where on-vehicle cameras are disposed on a vehicle.

FIG. 3 describes a method for generating a composite image.

FIG. 4 shows an example of a projection surface.

FIG. 5 shows operation-mode transition on the image display system of the first embodiment.

FIG. 6 shows an example of a display image in navigation mode.

FIG. 7 shows an example of a display image in front mode.

FIG. 8 explains a method for generating a composite image in front mode.

FIG. 9 shows an example of a display image in back mode.

FIG. 10 explains a method for generating a composite image in back mode.

FIG. 11 shows a processing flow on the image display system.

FIG. 12 shows operation-mode transition on an image display system of the second embodiment.

FIG. 13 shows an example of a display image in forward display mode.

FIG. 14 shows another example of the display image in forward display mode.

FIG. 15 shows another example of the display image in forward display mode.

FIG. 16 shows a configuration of an image display system of the third embodiment.

FIG. 17 shows operation mode transition on the image display system of the third embodiment.

FIG. 18 shows an example of a display image in close-passing mode.

FIG. 19 describes a method for generating a side image that covers the area in front of a vehicle.

FIG. 20 shows another example of the display image in close-passing mode.

FIG. 21 describes another method for generating a side image that covers the area behind the vehicle.

FIG. 22 shows a processing flow on the image display system in close-passing mode.

### DESCRIPTION OF THE EMBODIMENTS

Hereinafter, an embodiment of the invention is described with reference to attached drawings.

### 1. First Embodiment

### 1-1. Configuration

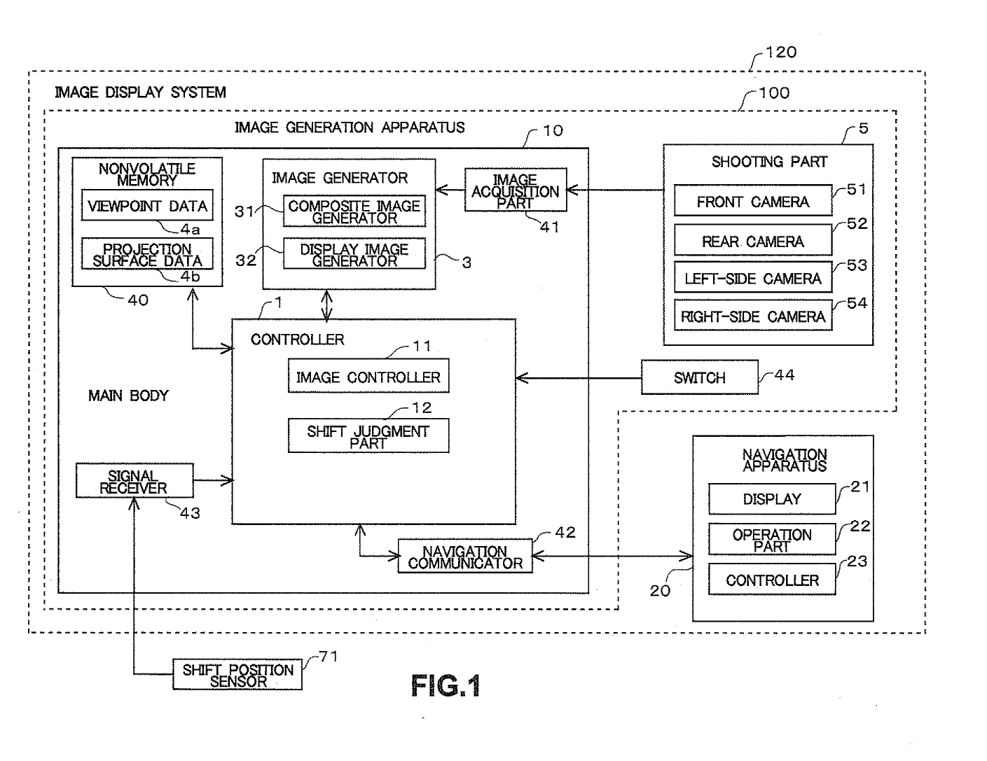

FIG. 1 shows a configuration of an image display system 120 of the first embodiment. The image display system 120 is to be used in a vehicle (a car in the embodiment) and has a function to display the image that shows the periphery of the vehicle on a display disposed in a vehicle cabin. A user (typically a driver) of the image display system 120 can check the periphery of the vehicle in almost real time by using the image display system 120.

As shown in FIG. 1, the image display system 120 mainly includes an image generation apparatus 100 that generates an image showing the periphery of the vehicle, and a navigation apparatus 20 that displays a variety of information for a user on the vehicle. The image generated by the image generation apparatus 100 is displayed on the navigation apparatus 20.

The major function of the navigation apparatus 20 is to provide route assistance for the user to get to a destination. The navigation apparatus 20 includes a display 21 such as a liquid crystal display having a touch panel, an operation part 22 such as a hardware switch which the user presses, and a controller 23 that controls the whole apparatus. The navigation apparatus 20 is installed in, for example, an instrument panel of the vehicle so that the user can look at the screen of the display 21 with ease.

User's operation is received through the operation part 22 or on the touch panel of the display 21. The controller 23 is a computer that includes a CPU, RAM, ROM, etc. Various kinds of functions including a route-guidance navigation function are performed by CPU processing of the controller 23 based on predetermined programs. The navigation apparatus 20 that is electrically connected to the image generation apparatus 100 is capable of transmitting and receiving various kinds of signals to and from the image generation apparatus 100, and is capable of receiving the image generated by the image generation apparatus 100.

The display 21 normally displays an image for route-guidance based on stand-alone functions of the navigation apparatus 20. When an operation mode of the image display system 120 is changed, the display 21 displays the image that shows the periphery of the vehicle and is generated by the image generation apparatus 100. That is, the navigation apparatus 20 also functions as a display apparatus that displays the image generated by the image generation apparatus 100.

The image generation apparatus 100 includes a shooting part 5 that acquires an image and a main body 10 that processes the image. The main body 10 generates a display image for display on the display 21 based on the image acquired by the shooting part 5.

The shooting part 5 acquires a shot image by capturing the periphery of the vehicle. The shooting part 5 has four on-vehicle cameras: a front camera 51, a rear camera 52, a left-side camera 53 and a right-side camera 54. Each of the on-vehicle cameras 51, 52, 53 and 54 having a lens and an image sensor acquires an image electronically. The shot images acquired by the on-vehicle cameras 51, 52, 53 and 54 are transmitted to the main body 10.

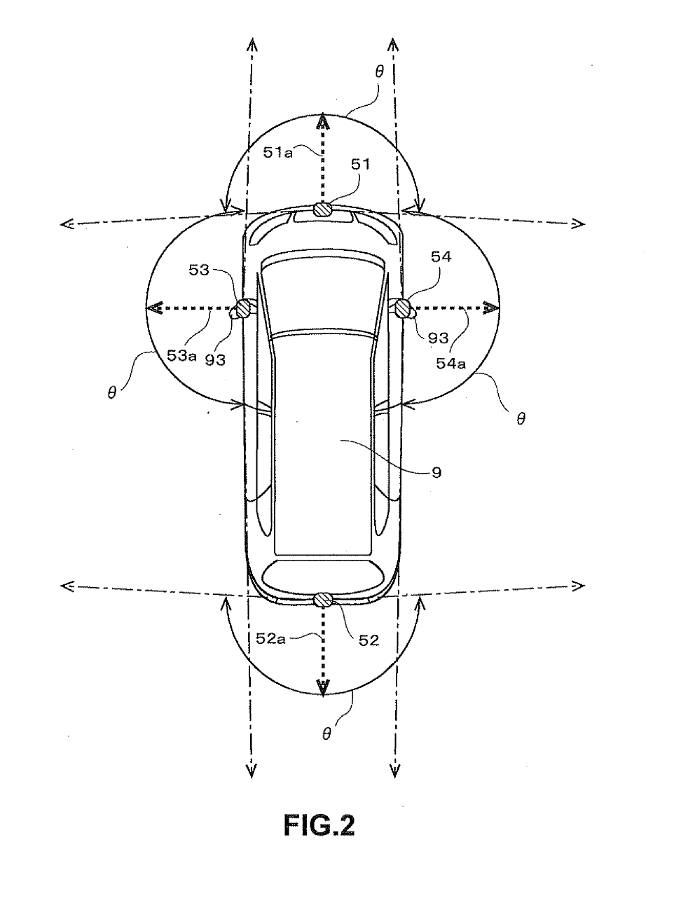

These on-vehicle cameras 51, 52, 53 and 54 that are respectively disposed at different locations on the vehicle capture the periphery of the vehicle in the different directions. FIG. 2 shows the locations where the on-vehicle cameras 51, 52, 53 and 54 are disposed on a vehicle 9.

As shown in FIG. 2, the front camera 51 is disposed near the center between the left-side end and the right-side end on the front end of the vehicle 9, and an optical axis 51a of the front camera 51 is pointed in the forward direction (the straight forward direction) of the vehicle 9. The rear camera 52 is disposed near the center between the left-side end and the right-side end on the rear end of the vehicle 9, and an optical axis 52a of the rear camera 52 is pointed in the backward direction (the direction opposite to the straight forward direction). The left-side camera 53 is disposed on a side-mirror 93 of the left side on the vehicle 9, and an optical axis 53a of the left-side camera 53 is pointed in the left direction (the direction perpendicular to the straight forward direction). The right-side camera 54 is disposed on the side-mirror 93 of the right side on the vehicle 9, and an optical axis 54a of the right-side camera 54 is pointed in the right direction (the direction perpendicular to the straight forward direction).

Each of the on-vehicle cameras 51, 52, 53 and 54 adopts a lens, such as a fish-eye lens, having a field angle θ of 180 degrees or more. Therefore, combination use of the four on-vehicle cameras 51, 52, 53 and 54 provides the shot images of the whole periphery of the vehicle 9.

Here is another description based on FIG. 1. The image generation apparatus 100 includes a switch 44 which the user can handle. When the user makes an operation with the switch 44, a signal containing the operation contents is transmitted to the main body 10. The switch 44 is disposed separately from the main body 10 in the vehicle cabin so that the location is suitable for user's handling.

Further, the main body 10 of the image generation apparatus 100 mainly includes an image acquisition part 41 that acquires a shot image from the shooting part 5, an image generator 3 that generates a display image, a navigation communicator 42 that communicates with the navigation apparatus 20, a signal receiver 43 that receives a signal from another apparatus, and a controller 1 that controls the whole of the image display system 120.

The image acquisition part 41 acquires the shot images respectively from the four on-vehicle cameras 51, 52, 53 and 54 of the shooting part 5. Therefore, the image acquisition part 41 acquires the four shot images, each of which shows the front area, the rear area, the left-side area or the right-side area of the vehicle 9.

The image generator 3 is a hardware circuit that is capable of various kinds of image processing. The image generator 3 generates the display image for display on the display 21 by processing the shot image acquired by the image acquisition part 41. The image generator 3 includes a composite image generator 31 and a display image generator 32 as the major functions of the image generator 3.

The composite image generator 31 generates a composite image that shows the periphery of the vehicle 9 viewed from a virtual viewpoint, based on the shot images acquired by the four on-vehicle cameras 51, 52, 53 and 54. The method for generating the composite image by the composite image generator 31 is described later.

The display image generator 32 generates the display image for display on the display 21 by use of the shot image acquired by the shooting part 5 and of the composite image generated by the composite image generator 31. The display image generator 32 adjusts the shot image and composite image to make them in prescribed sizes by image processing, such as scaling or clipping. Then, the display image generator 32 generates the display image by setting the shot image and the composite image at prescribed locations.

The navigation communicator 42 transmits and receives a signal to and from the navigation apparatus 20. The navigation communicator 42 transmits the display image generated by the display image generator 32 to the navigation apparatus 20. This allows the display 21 of the navigation apparatus 20 to display the display image that shows the periphery of the vehicle 9. When the user performs operation for the operation part 22 or on the display 21 of the navigation apparatus 20, the navigation communicator 42 receives the signal that represents the operation contents, and transmits the signal to the controller 1.

The signal receiver 43 receives a signal from another apparatus that is installed separately from the image display system 120 on the vehicle 9. The signal receiver 43 receives from a shift position sensor 71a signal relevant to a shift position that indicates a shift lever position in a gearbox on the vehicle 9, and transmits the signal to the controller 1.

The controller 1 is a computer that collectively controls the whole of the image display system 120. The controller 1 that includes a CPU, RAM, ROM, etc. implements various kinds of control functions by CPU processing based on prescribed programs. When the user handles the navigation apparatus 20 or the switch 44, the signal representing the operation contents is transmitted to the controller 1. To respond to the signal, the controller 1 controls the image display system 120 based on the instruction conforming to the operation by the user.

An image controller 11 and a shift determining part 12 shown in FIG. 1 are a part of the functions of the controller 1 that are implemented by processing based on programs.

The image controller 11 controls the image processing implemented by the image generator 3. In an example, the image controller 11 provides to the composite image generator 31 various kinds of the parameters required for composite image generation. The image controller 11 also instructs the display image generator 32 on an appropriate display image in accordance with the operation mode of the image display system 120 and the traveling direction of the vehicle.

The shift determining part 12 determines which is the current shift lever position, “P” (Parking), “D” (Driving), “N” (Neutral) or “R (Reverse),” based on the signal transmitted from the shift position sensor 71 of the vehicle 9. That is, the shift determining part 12 substantially determines whether the traveling direction of the vehicle 9 is the forward direction or the backward direction.

Further, the main body 10 includes a nonvolatile memory 40 that is capable of maintaining memory contents even in a power-off state. The nonvolatile memory 40 is, for example, a hard disk and a flash memory. The nonvolatile memory 40 stores viewpoint data 4a and projection surface data 4b. The viewpoint data 4a and the projection surface data 4b are used for composite image generation.

### 1-2. Composite Processing

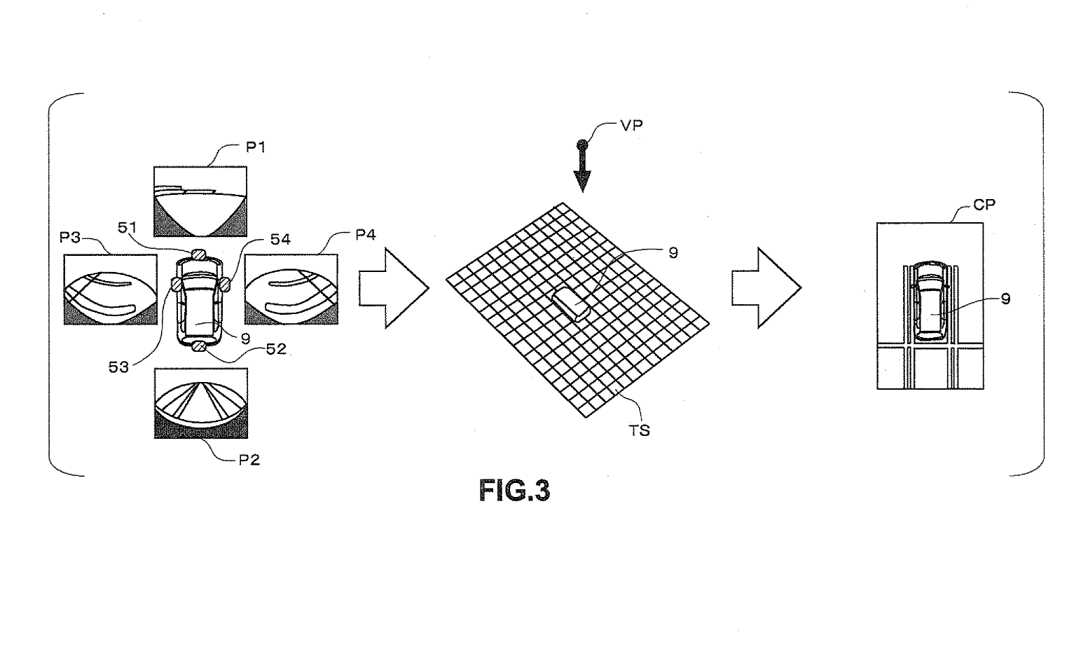

Here is a description about the method where the composite image generator 31 of the image generator 3 generates the composite image that shows the periphery of the vehicle 9 viewed from a virtual viewpoint. FIG. 3 describes the method for generating the composite image.

Upon capturing by each of the front camera 51, the rear camera 52, the left-side camera 53 and the right-side camera 54, each of four shot images P1, P2, P3 and P4 is acquired. The shot image P1 shows the area in front of the vehicle 9. The shot image P2 shows the area behind. The shot image P3 shows the left side. The shot image P4 shows the right side. The four shot images P1, P2, P3 and P4 overall include the data covering the whole area around the vehicle 9.

The data (each pixel value) of the four shot images P1, P2, P3 and P4 that are acquired as above are projected onto a projection surface TS that is virtually created. The center of the projection surface TS is designated as the location of the vehicle 9. The area except the designated area on the projection surface TS corresponds to the data of the shot images P1, P2, P3 and P4 in advance, and the corresponding data are projected onto the projection surface TS.

In the area in front of the vehicle 9 on the projection surface TS, the data of the shot image P1 acquired by the front camera 51 is projected. In the area behind the vehicle 9 on the projection surface TS, the data of the shot image P2 acquired by the rear camera 52 is projected. In the left-side area of the vehicle 9 on the projection surface TS, the data of the shot image P3 acquired by the left-side camera 53 is projected. In the right-side area of the vehicle 9 on the projection surface TS, the data of the shot image P4 acquired by the right-side camera 54 is projected.

Further, the image of the vehicle 9 is superposed at the position designated as the location of the vehicle 9 on the projection surface TS. The image of the vehicle 9 is prepared as a bitmap image or the like, and stored in the nonvolatile memory 40 in advance. As above, the data for the whole area of the projection surface TS are determined.

Upon the determination of the data of the whole of the projection surface TS, a virtual viewpoint VP is set. Concretely, the virtual viewpoint VP is set so that the vehicle 9 and the periphery of the vehicle 9 are looked down from the virtual viewpoint VP. Within the projection surface TS, the area included in the prescribed angular range viewed from the set virtual viewpoint VP is clipped. The image clipped as above is determined as a composite image CP that shows the periphery of the vehicle 9 viewed from the virtual viewpoint VP.

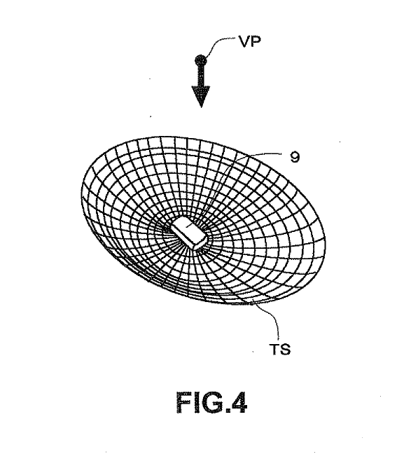

The projection surface TS in FIG. 3 is shown as a flat surface. However, the composite image generator 31 is capable of changing the projection surface TS for composite image generation from the flat surface to another shape. In an example, the composite image generator 31 may trace the projection surface TS on curved three dimension of a substantially-hemispherical shape (bowl shape) as shown in FIG. 4. The composite image generator 31 is capable of arbitrarily moving the point of the virtual viewpoint VP. Upon the move of the virtual viewpoint VP, the area clipped from the projection surface TS as the composite image CP is changed accordingly.

### 1-3. Operation Mode

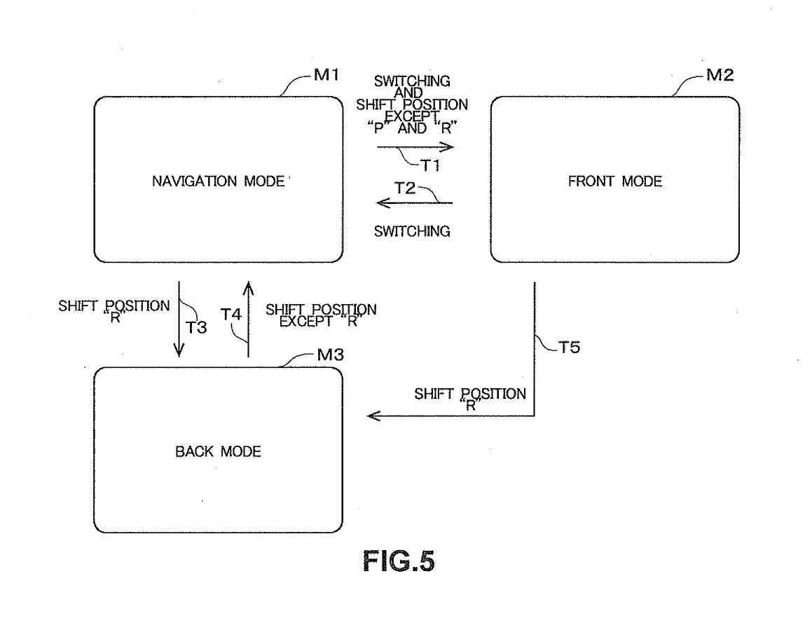

Next, operation modes on the image display system 120 are described. FIG. 5 shows operation-mode transition on the image display system 120.

The image display system 120 has three operation modes: a navigation mode M1, a front mode M2, and a back mode M3. The navigation mode M1 activates the functions of the navigation apparatus 20.

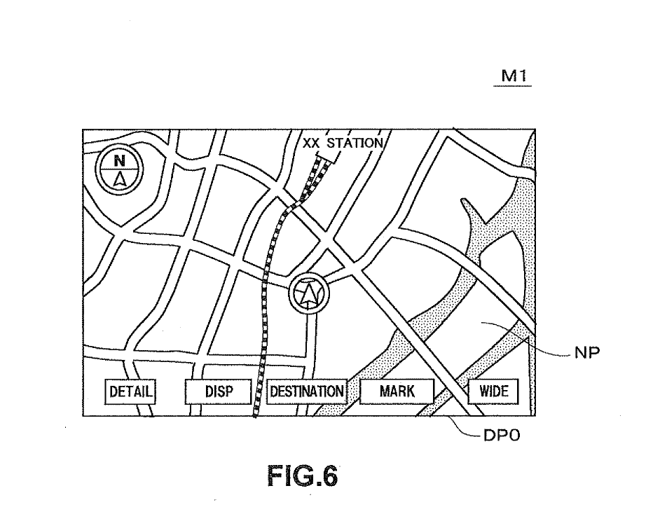

In the navigation mode M1, a variety of information is displayed on the display 21 based on the stand-alone functions of the navigation apparatus 20 with no use of the functions of the image generation apparatus 100. FIG. 6 shows an example of a display image DP0 for display in the navigation mode. The display image DP0 includes a map image NP that shows the location of the vehicle 9.

Here is another description based on FIG. 5. Each of the front mode M2 and the back mode M3 provides the display image that shows the periphery of the vehicle 9 on the display 21 by use of the functions of the image generation apparatus 100. In these operation modes, the user can understand the states of the periphery of the vehicle 9 in almost real time. The front mode M2 mainly provides the display image of the area in front of the vehicle 9. On the other hand, the back mode M3 mainly provides the display image of the area behind the vehicle 9.

The controller 1 is capable of switching among these operation modes based on user's operation or the shift lever position. In an example, pressing the switch 44 in the navigation mode M1 under the situation where the shift lever is set at a position except “P” and “R” changes the operation mode to the front mode M2 (arrow T1). Moreover, pressing the switch 44 in the front mode M2 changes the operation mode back to the navigation mode M1 (arrow T2).

Moving the shift lever to the position of “R” in the navigation mode M1 or the front mode M2 changes the operation mode to the back mode M3 (arrows T3 and T5). Moving the shift lever to a position except “R” in the back mode M3 changes the operation mode back to the navigation mode M1 (arrow T4).

When the shift lever is set at “R,” the traveling direction of the vehicle 9 is the backward direction. Thus, the operation mode is changed, according to the user's needs, to the back mode M3 that mainly displays the area behind the vehicle 9. On the other hand, when the shift lever is set at a position except “P” and “R,” the traveling direction of the vehicle 9 is the forward direction. Thus, the operation mode is changed to the front mode M2 that mainly provides the display image of the area in front of the vehicle 9.

The image generator 3 changes the form of the display image to be generated in accordance with the operation mode. Thus, the front mode M2 and the back mode M3 provide display images in different forms for display on the display 21 respectively.

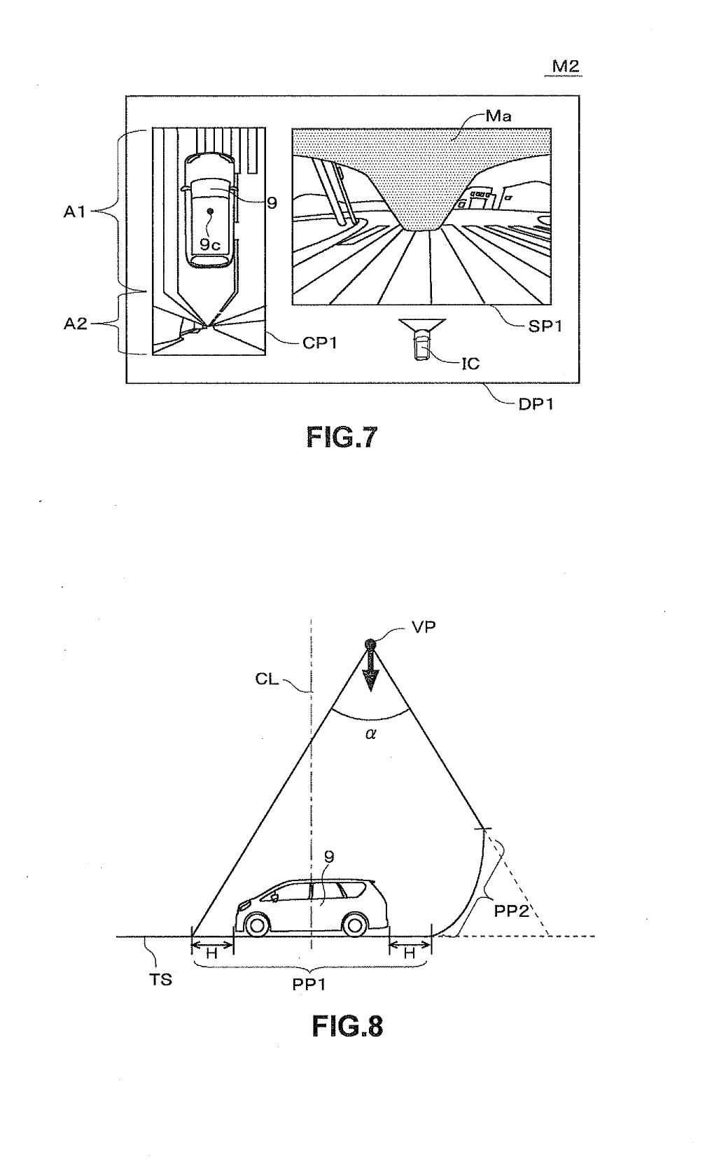

FIG. 7 shows an example of a display image DP1 in the front mode M2. The display image DP1 includes a forward image SP1, a composite image CPI and an icon IC which are placed side by side. The icon IC shows in symbolic form the periphery of the vehicle 9 shown in the forward image SP1.

The forward image SP1 that shows the area in front of the vehicle 9 is processed based on the shot image acquired by the front camera 51. In the front mode M2, the traveling direction of the vehicle 9 is the forward direction. At the time, the user can notice the object forward that exists in the traveling direction of the vehicle 9 by looking at the forward image SP1. The forward image SP1 includes a mask area Ma that partially hides the image in front of the vehicle 9.

The composite image CP1 shows a peripheral area A1 as the periphery of the vehicle 9 and a backward area A2 as the area behind the vehicle 9. The peripheral area A1 is in a rectangle shape that has prescribed distances (e.g. 2 meters) respectively from the front surface, the rear surface, the left-side surface and the right-side surface of the vehicle 9 that is centered in the rectangle shape. The composite image CP1 includes the peripheral area A1 that centers the image of the vehicle 9 and is viewed from a virtual viewpoint that looks down the vehicle 9. The backward area A2 shows the area in the area behind the vehicle 9, which also includes an outside of the peripheral area A1.

The composite image CP1 shows the peripheral area A1 and the backward area A2 in a seamless form. That is, the composite image CP1 has no boundary line for separating the peripheral area A1 and the backward area A2, and shows the seamless image of the object spreading in the peripheral area A1 and the backward area A2 when the object exists in the location corresponding to the both areas of the peripheral area A1 and the backward area A2.

The user can notice the object backward that exists in the direction opposite to the traveling direction of the vehicle 9 by looking at the composite image CP1. Since the composite image CP1 shows the peripheral area A1 and the backward area A2 seamlessly, the user can immediately understand the location of the object that exists in the area behind the vehicle 9.

The peripheral area A1 and the backward area A2 may be separated as different images and displayed side by side. However, on the separate images, it is difficult for the user to understand the positional relation between the peripheral area A1 and the backward area A2. Then, this makes it difficult for the user to immediately understand the position of the object that exists in the backward area A2, if any. Also, while an object moves from the backward area A2 to the peripheral area A1, the image of the object moves from the image of the backward area A2 to the image of the peripheral area A1. This may cause the user to lose sight of the image of the object.

On the other hand, since the composite image CP1 of the embodiment shows, in a seamless manner, the backward area A2 and the peripheral area A1 that includes the position of the vehicle 9, the user can immediately understand the relative position to the vehicle 9, of the object that exists in the area behind the vehicle 9. Further, even while the image of the object moves from the backward area A2 to the peripheral area A1, the image of the object moves within the composite image CP1. Thus, the user does not lose sight of the image of the object.

The user can check the state of the area behind the vehicle 9 and the state of the area in front of the vehicle 9 as well, by looking at the display image DP1 shown in FIG. 7. Thus, the user can notice the object backward that exists in the direction opposite to the traveling direction while paying attention to the front in the traveling direction of the vehicle 9.

FIG. 8 explains a method by which the composite image generator 31 generates the composite image CP1 included in the display image DP1 shown in FIG. 7. As shown in FIG. 8, the composite image CP1 uses the projection surface TS including a part PP1 that is created on a flat surface (horizontal surface) and a part PP2 that is created on a curved surface. The part PP1 includes the peripheral area A1, and the part PP2 includes the backward area A2. The part PP2 is convex downward. One end of the part PP2 on the vehicle side is contiguous with the flat part PP1. The longer the distance from the vehicle 9 is, the steeper to the part PP1 the slope of the part PP2 is.

That is, on the projection surface TS, the part PP1 that centers the vehicle 9 and has a margin of a prescribed distance H from each side of the vehicle 9, is created on the flat surface. The data of the peripheral area A1 is projected onto the flat part PP1. On the other hand, on the projection surface TS, the part PP2 which includes the outside of the part PP1 and is in the backward direction of the vehicle 9, is created on the curved surface. The data of the backward area A2 is projected onto the curved part PP2. The data of the shape of the projection surface TS is included in the projection surface data 4b stored in the nonvolatile memory 40.

The virtual viewpoint VP is set posterior to a center line CL that is set at the center between the front end line and the rear end line of the vehicle 9. The data of the point of the virtual viewpoint VP is included in the viewpoint data 4a stored in the nonvolatile memory 40. The composite image CP1 shows the area which is viewed from the virtual viewpoint VP in a prescribed angle α on the projection surface TS.

As above, the virtual viewpoint VP is set posterior to the center line CL that is set at the center between the front end line and the rear end line of the vehicle 9. Thus, on the composite image CP1 shown in FIG. 7, a center point 9c of the image of the vehicle 9 is shown above the center line that is set horizontally at the vertical center of the composite image CP1. This makes the backward area A2 wider on the composite image CP1. Therefore, it becomes easier for a user to notice the object backward that exists in the direction opposite to the traveling direction of the vehicle 9.

If a composite image were generated based on the projection surface TS only including the flat surface, the farther from the location of the vehicle 9 an object would exist, the bigger the image of the object projected onto the projection surface TS would become. Therefore, while the image of the object existing near the vehicle 9 has less distortion, the image of the object existing away from the vehicle 9 has larger distortion. Moreover, the composite image includes only the rather narrow area in the peripheral of the vehicle 9.

On the other hand, in the embodiment, the data of the backward area A2 away from the vehicle 9 is projected onto the curved part PP2 of the projection surface TS. This reduces the distortion of the image of the object that exists away from the vehicle 9, and generates the composite image CPI that includes the rather wide area in the peripheral of the vehicle 9. Further, the data of the peripheral area A1 near the vehicle 9 is projected onto the flat part PP1 of the projection surface TS. This provides effective use of the image that has less distortion, and allows a user to pinpoint the precise location of the object existing near the vehicle 9.

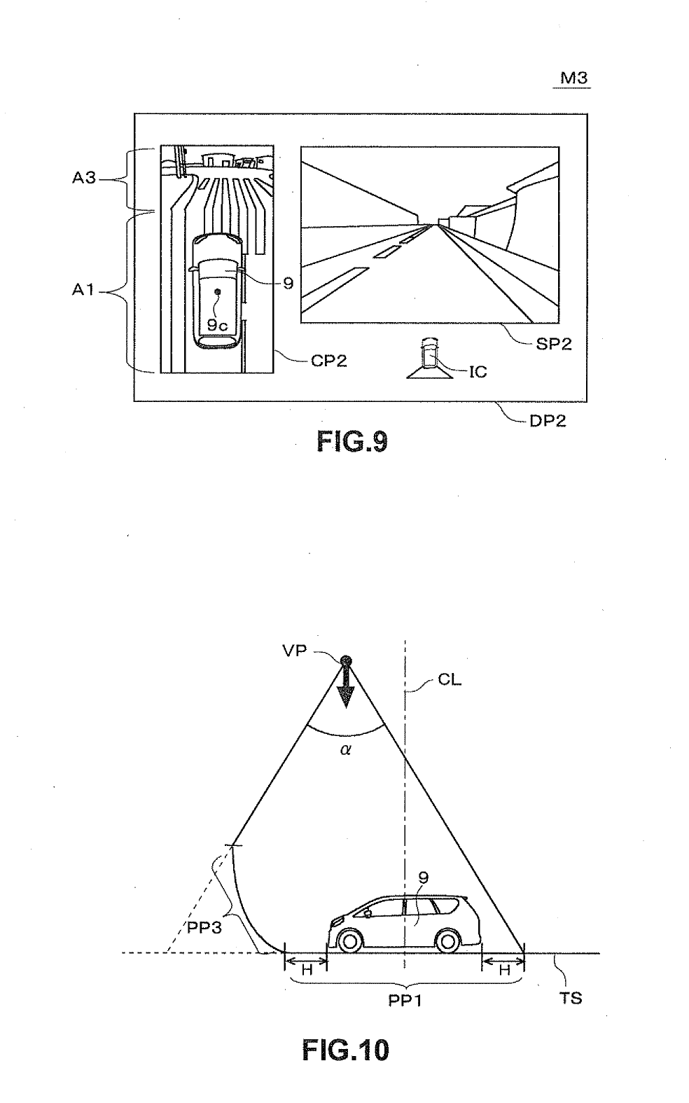

FIG. 9 shows an example of a display image DP2 in the back mode M3. The display image DP2 includes a backward image SP2, a composite image CP2 and the icon IC which are placed side by side. The icon IC shows in symbolic form the peripheral area of the vehicle 9 shown in the backward image SP2.

The backward image SP2 that shows the area behind the vehicle 9 is processed based on the shot image acquired by the rear camera 52. In the back mode M3, the traveling direction of the vehicle 9 is the backward direction. At the time, the user can notice the object backward that exists in the traveling direction of the vehicle 9 by looking at the backward image SP2.

The composite image CP2 shows the peripheral area A1 as the peripheral area of the vehicle 9 and a forward area A3 as the area in front of the vehicle 9. The composite image CP2 also includes the peripheral area A1 that centers the image the image of the vehicle 9 and is viewed from a virtual viewpoint that looks down the vehicle 9. The forward area A3 shows the area in the area in front of the vehicle 9, which includes the outside of the peripheral area A1.

The composite image CP2 shows the peripheral area A1 and the forward area A3 in a seamless manner. That is, the composite image CP2 has no boundary line for separating the peripheral area A1 and the forward area A3, and shows the seamless image of the object spreading in the peripheral area A1 and the forward area A3 when the object exists at the location corresponding to the both areas of the peripheral area A1 and the forward area A3.

The user can notice the object forward that exists in the direction opposite to the traveling direction of the vehicle 9 by looking at the composite image CP2. Since the composite image CP2 shows the peripheral area A1 and the forward area A3 in a seamless manner, the user can immediately understand the relative position to the vehicle 9, of the object that exists in the area in front of the vehicle 9. While an object moves from the forward area A3 to the peripheral area A1, the image of the object moves within the composite image CP2. Thus, the user does not lose sight of the image of the object

The user can check the state of the area behind the vehicle 9 and the state of the area in front of the vehicle 9 as well, by looking at the display image DP2 shown in FIG. 9. Thus, the user can notice the object forward that exists in the direction opposite to the traveling direction while paying attention to the area behind the vehicle 9 in the traveling direction.

FIG. 10 explains a method by which the composite image generator 31 generates the composite image CP2 included in the display image DP2 shown in FIG. 9. As shown in FIG. 10, the composite image CP2 uses the projection surface TS including the part PP1 that is created on a flat surface (horizontal surface) and a part PP3 that is created on a curved surface. The part PP1 includes the peripheral area A1, and a part PP3 includes the forward area A3. The part PP3 is convex downward. One end of the part PP3 on the vehicle side is contiguous with the flat part PP1. The longer the distance from the vehicle 9 is, the steeper against the part PP1 the slope of the part PP3 is.

That is, on the projection surface TS, the part PP1 that centers the vehicle 9 and has a margin of the prescribed distance H from each side of the vehicle 9, is created on the flat surface. The data of the peripheral area A1 is projected onto the flat part PP1. On the other hand, on the projection surface TS, the part PP3 that includes the outside of the part PP1 and is in the forward direction of the vehicle 9, is created on the curved surface. The data of the forward area A3 is projected onto the curved part PP3. The data of the shape of the projection surface TS is included in the projection surface data 4b stored in the nonvolatile memory 40.

The virtual viewpoint VP is set anterior to the center line CL that is set at the center between the front end line and the rear end line of the vehicle 9. The data of the point of the virtual viewpoint VP is included in the viewpoint data 4a stored in the nonvolatile memory 40. The composite image CP2 shows the area which is viewed from the virtual viewpoint VP in the prescribed angle α on the projection surface TS.

As above, the virtual viewpoint VP is set anterior to the center line CL that is set at the center between the front end line and the rear end line of the vehicle 9. Thus, on the composite image CP2 shown in FIG. 9, the center point 9c of the image of the vehicle 9 is shown below the center line that is set horizontally at the vertical center of the composite image CP2. This makes the forward area A3 wider on the composite image CP2. Therefore, it becomes easier for the user to notice the object forward that exists in the direction opposite to the traveling direction of the vehicle 9.

The data of the forward area A3 away from the vehicle 9 is projected onto the curved part PP3 of the projection surface TS. This reduces the distortion of the image of the object that exists away from the vehicle 9, and generates the composite image CP2 that includes the rather wide peripheral area of the vehicle 9. Further, the data of the peripheral area A1 near the vehicle 9 is projected onto the flat part PP1 of the projection surface TS, as well. This provides effective use of the image that has less distortion, and allows the user to accurately pinpoint the precise location of the object existing near the vehicle 9.

### 1-4. Processing

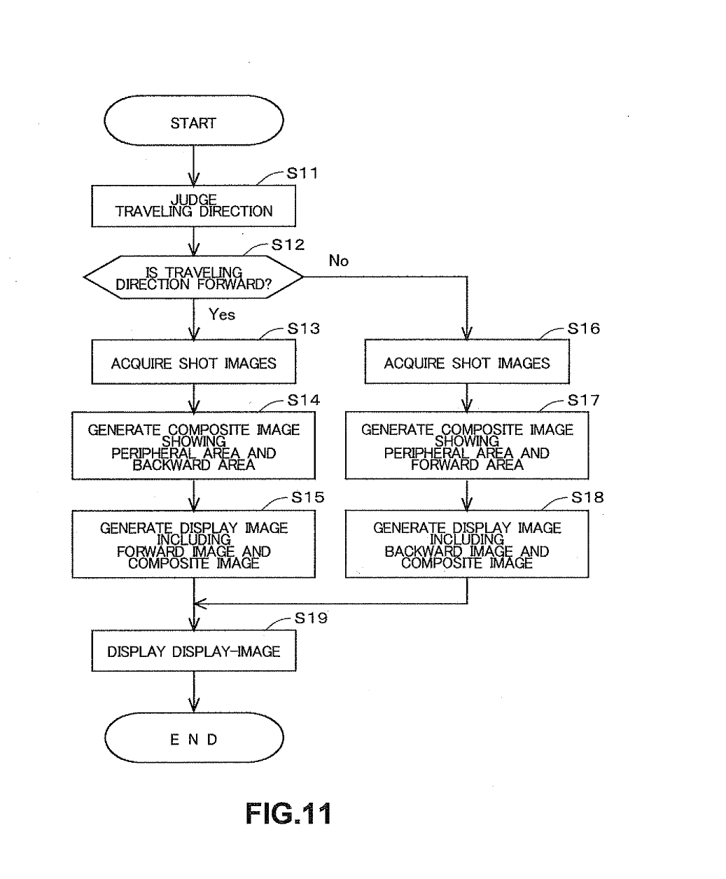

Next, a processing flow on the image display system 120 is described. FIG. 11 shows a processing flow when the image display system 120 displays the display image that shows the periphery of the vehicle 9 (in the front mode M2, or in the back mode M3). When the operation mode is the front mode M2 or the back mode M3, the processing shown in FIG. 11 is repeated at a prescribed interval (e.g. 1/30 second).

First, the shift determining part 12 determines the current shift lever position based on the signal transmitted from the shift position sensor 71. That is, the shift determining part 12 substantially determines the current traveling direction of the vehicle 9 (step S11). Hereafter, the processing methods vary in accordance with the traveling direction of the vehicle 9.

When the traveling direction of the vehicle 9 is the forward direction (that is, in the front mode M2) (Yes at the step S12), first, the image acquisition part 41 acquires four shot images from each of the four on-vehicle cameras 51, 52, 53 and 54 (step S13).

Next, the composite image generator 31 generates, using the shot images, the composite image CPI that shows the peripheral area A1 and the backward area A2 in a seamless manner by the method described based on FIG. 8 (step S14). Then, the display image generator 32 generates the display image DPI (refer to FIG. 7) including the composite image CP1 and the forward image SP1 that shows the area in front of the vehicle 9 (step S15).

The display image DP1 generated as described above is transmitted from the navigation communicator 42 to the navigation apparatus 20. Thus, the display image DP1 is displayed on the display 21 of the navigation apparatus 20 (step S19).

When the traveling direction of the vehicle 9 is the backward direction (that is, in the back mode M3) (No at the step S12), first, the image acquisition part 41 acquires the four shot images from each of the four on-vehicle cameras 51, 52, 53 and 54 (step S16).

Next, the composite image generator 31 generates, using the shot images, the composite image CP2 that shows the peripheral area A1 and the forward area A3 in a seamless manner by the method described based on FIG. 10 (step S17). Then, the display image generator 32 generates the display image DP2 (refer to FIG. 9) including the composite image CP2 and the backward image SP2 that shows the area behind the vehicle 9 (step S18).

The display image DP2 generated as described above is transmitted from the navigation communicator 42 to the navigation apparatus 20. Thus, the display image DP2 is displayed on the display 21 of the navigation apparatus 20 (step S19)

As described above, on the image display system 120 of the first embodiment, the shift determining part 12 determines the traveling direction of the vehicle 9. Then, the composite image generator 31 generates the composite image that shows, in a seamless manner, the peripheral area A1 and the area that includes the outside of the peripheral area A1 of the vehicle 9, and that is in the direction opposite (the backward area A2 or the forward area A3) to the traveling direction. The peripheral area A1 shows the peripheral area of the vehicle 9 viewed from a virtual viewpoint that is set looking down at the vehicle 9. The display 21 displays the display image including the composite image. Since the display image includes the composite image that shows the area in the direction opposite to the traveling direction of the vehicle 9, the user can notice the object that exists in the direction opposite to the traveling direction of the vehicle 9 by looking at the display image. Besides, since the peripheral area A1 and the area in the direction opposite to the traveling direction of the vehicle 9 are displayed in a seamless manner, the user can immediately pinpoint the location of the object that exists in the direction opposite to the traveling direction of the vehicle 9.

### 2. Second Embodiment

Next, the second embodiment is described. The operation and the processing on the image display system of the second embodiment are almost the same as the ones of the first embodiment. Thus, the points different from the first embodiment are mainly described. In the first embodiment, when the traveling direction of the vehicle 9 is the backward direction (that is, in the back mode M3), displayed is the display image including the backward image, but is not the one including the forward image.

On the other hand, in the second embodiment, when the traveling direction of a vehicle 9 is the backward direction, a user can switch between a display image that includes the backward image and another display image that includes the forward image by operation. Concretely, when the traveling direction of the vehicle 9 is the backward direction, an image generator 3 selectively generates one of the display image including the backward image and the display image including the forward image in accordance with the user's operation. Then, the generated display image is displayed on a display 21. In the second embodiment, this allows the user to check the area in front of the vehicle 9 in the display image if needed, even when the traveling direction of the vehicle 9 is the backward direction.

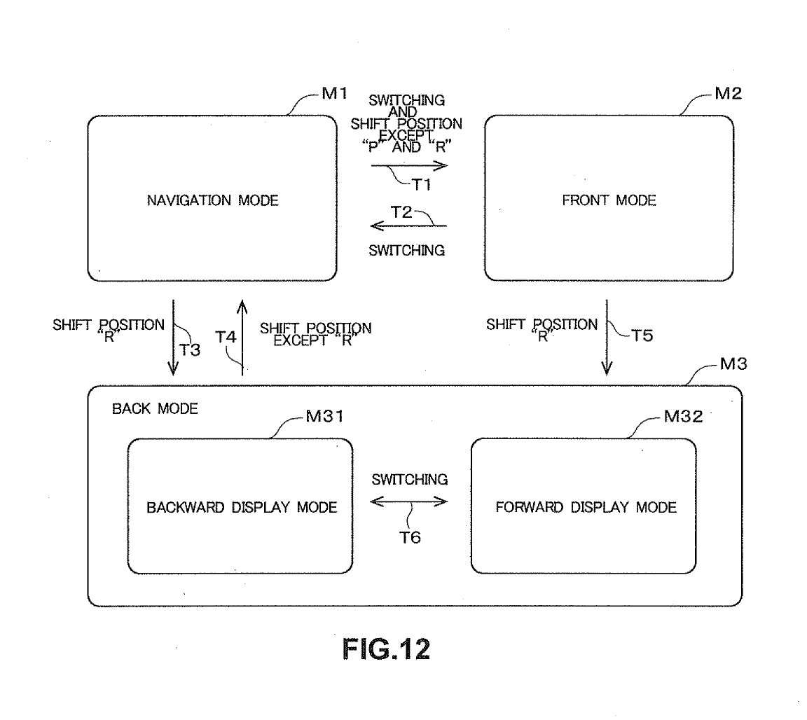

FIG. 12 shows operation mode transition on an image display system 120 of the second embodiment. In the second embodiment as well, the image display system 120 has three operation modes: a navigation mode M1, a front mode M2, and the back mode M3. These operation modes are switched as well as in the first embodiment (arrows T1, T2, T3, T4 and T5). In the front mode M2, a display image DP1 (refer to FIG. 7) that is generated in the same form as the first embodiment is displayed on the display 21.

However, in the second embodiment, the back mode M3 includes two sub-modes. One of the sub-modes is a backward display mode M31 that mainly provides the display image of the area behind the vehicle 9, and the other of the sub-modes is a forward display mode M32 that mainly provides the display image of the area in front of the vehicle 9. Immediately after the operation mode is switched to the back mode M3, the sub-mode is the backward display mode M31. Then, every time the user presses a switch 44, the sub-mode is switched between the backward display mode M31 and the forward display mode M32 (arrow T6). That is, every time the user presses the switch 44, the image generator 3 generates display images in different forms, and then the generated display image are displayed on the display 21.

In the backward display mode M31, the display image including the backward image that shows the area behind the vehicle 9 is generated and displayed on the display 21. On the other hand, in the forward display mode M32, the display image including the forward image that shows the area in front of the vehicle 9 is generated and displayed on the display 21. The form of the display image in the backward display mode M31 is identical to the display image DP2 (refer to FIG. 9) in the back mode M3 of the first embodiment. On the other hand, the form of the display image in the forward display mode M32 is different from the display image DP1 (refer to FIG. 7) in the front mode M2.

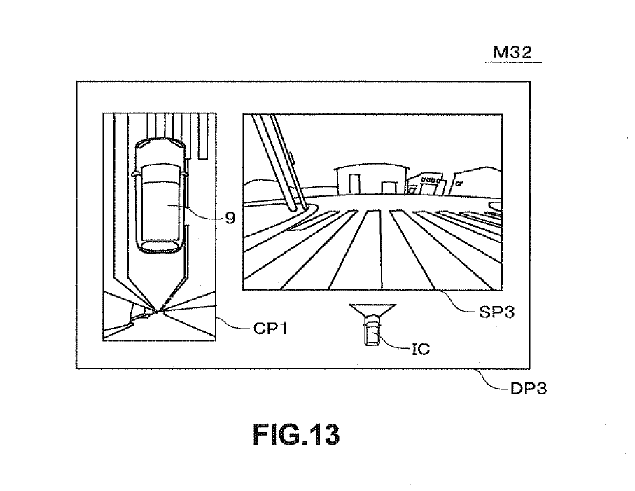

FIG. 13 shows an example of a display image DP3 in the forward display mode M32. The display image DP3 includes a forward image SP3, a composite image CP1 and an icon IC which are placed side by side. The forward image SP3 that shows the area in front of the vehicle 9 is processed based on the shot image acquired by a front camera 51. The icon IC shows in symbolic form the periphery of the vehicle 9 shown in the forward image SP3.

As seen in the comparison between FIG. 7 and FIG. 13, different are the form of the forward image SP1 included in the display image DP1 in the front mode M2 and the form of the forward image SP3 included in the display image DP3 in the forward display mode M32. As described above, the forward image SP1 (refer to FIG. 7) in the front mode M2 includes the non-transparent mask area Ma that partially hides the area in front of the vehicle 9. On the other hand, the forward image SP3 (refer to FIG. 13) in the forward display mode M32 does not include such a mask area. As above, the display image DP3 in the forward display mode M32 shows the forward of the vehicle 9 in the form different from the display image DPI in the front mode M2.

If the display image in the forward display mode M32 were generated in the same form as the display image in the front mode M2, the user might take the front mode M2 as the current operation mode on the image display system 120 when the user looks at the display image in the forward display mode M32. In other words, the user, when looking at the display image in the forward display mode M32, might mistake the forward direction for the current traveling direction of the vehicle 9. On the other hand, in the embodiment, the display image DP1 in the front mode M2 and the display image DP3 in the forward display mode M32 are in different forms, which prevents the user from mistaking the traveling direction of the vehicle 9.

In the front mode M2, the traveling direction of the vehicle 9 is the forward direction. Thus, it is preferable for the user to see the area with his or her own eyes if the area can be seen directly. The forward image SP1 in the front mode M2 includes the mask area Ma partially hiding the area that the user can directly check within the area in front of the vehicle 9, and mainly shows the area that is hardly checked by the user directly (the blind area for the user).

On the other hand, the forward display mode M32 provides a display image so that the user can check the area in front of the vehicle 9 when the traveling direction of the vehicle 9 is the backward direction. Thus, displaying the wider area in the front of the vehicle 9 is desired for the driver to check. Therefore, the display image DP3 in the forward display mode M32 can show the wide area in front of the vehicle 9 without any mask area.

As shown in the example of FIG. 13, the forward image SP3 in the forward display mode M32 includes no mask area. However, if the display image DP3 in the forward display mode M32 is obviously distinct from the display image DP1 in the front mode M2, the forward image SP3 in the forward display mode M32 may include the mask area.

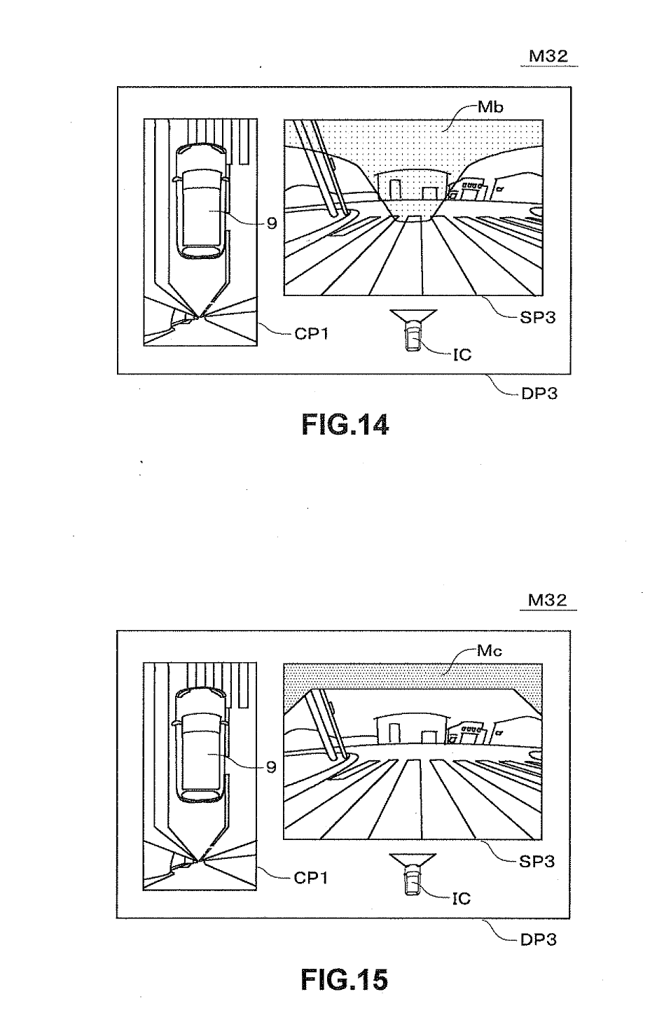

As shown in the example of FIG. 14, the forward image SP3 in the forward display mode M32 may include a mask area Mb that is a transparent mask area. The user can see the whole area in front of the vehicle 9 even if the forward area includes the mask area Mb. Therefore, the display image DP3 shown in FIG. 14 shows a wider area in front of the vehicle 9.

As shown in FIG. 15, the forward image SP3 in the forward display mode M32 may include a mask area Mc that is different in shape from the mask area Ma in the front mode M2. Upon the use of the mask areas in these obviously-different shapes between the display image DP1 in the front mode M2 and the display image DP3 in the forward display mode M32, the user can obviously tell which operation mode the currently-displayed display image is. This allows the user to immediately understand the current traveling direction of the vehicle 9.

As described above, on the image display system 120 of the second embodiment, the display image DP3 that shows the area in front of the vehicle 9 when the traveling direction of the vehicle 9 is the backward direction is shown differently in form from the display image DP1 that also shows the area in front of the vehicle 9 when the traveling direction of the vehicle 9 is the forward direction. This prevents the user from mistaking the traveling direction of the vehicle 9.

### 3. Third Embodiment

Next, the third embodiment is described. The operation and the processing on the image display system of the third embodiment are almost the same as the ones of the first embodiment. Thus, the points different from the first embodiment are mainly described.

On the conventional image display systems, the case where a side-mirror is retracted is not concerned. The cases where the side-mirror of a vehicle is retracted are commonly seen at parking, and further when the side surface of the vehicle is close to an object, such as when the vehicle passes close by another vehicle, or when the vehicle runs on a rather narrow street. Thus, when the side-mirror is retracted under the situation where the vehicle is ready for running, it is assumed that a vehicle 9 will get close to an object. Therefore, when a side-mirror 93 is retracted, an image display system 120 of the third embodiment displays a useful display image when the vehicle 9 runs in the case where the side surface of the vehicle 9 is close to an object.

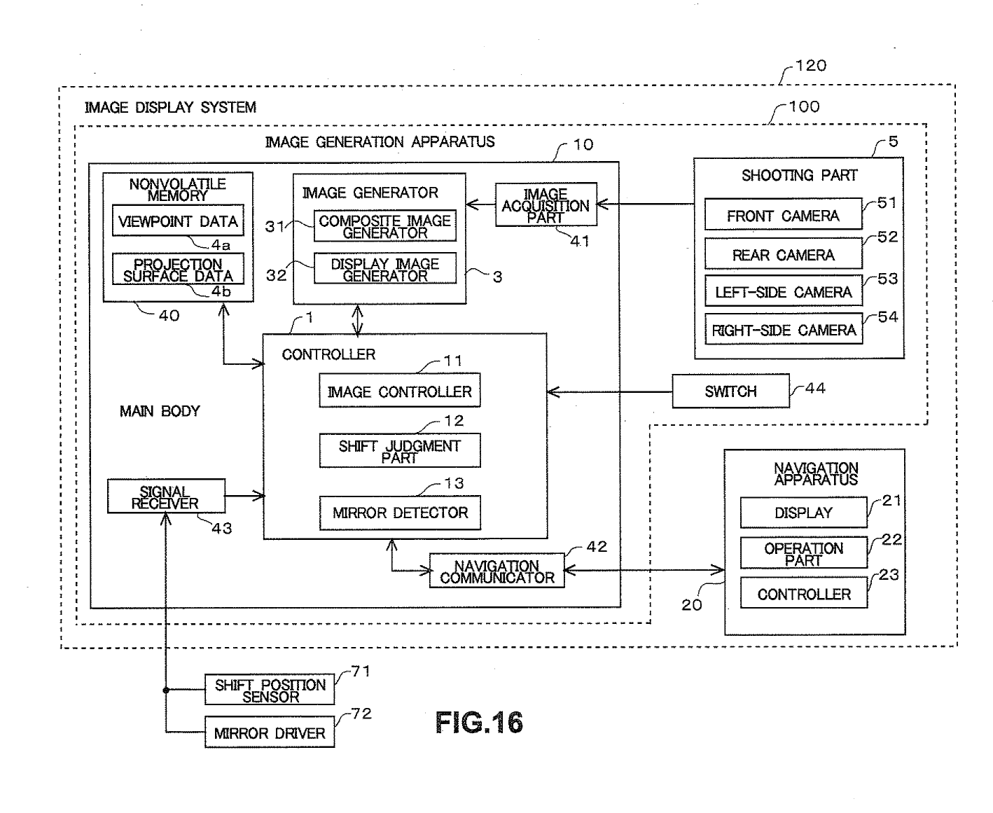

FIG. 16 shows a configuration of the image display system 120 of the third embodiment. In the third embodiment, a controller 1 includes an image controller 11 and a shift determining part 12, and further includes a mirror detector 13, as functions implemented by arithmetic processing based on programs. Other components of the image display system 120 of the third embodiment are identical with the ones of the image display system 120 of the first embodiment. The mirror detector 13 detects the state (retracted or opened) of the side-mirror 93 based on the signal transmitted from a mirror driver 72 that drives the side-mirror 93 of the vehicle 9. The mirror driver 72 retracts or opens the side-mirror 93 based on user's instruction.

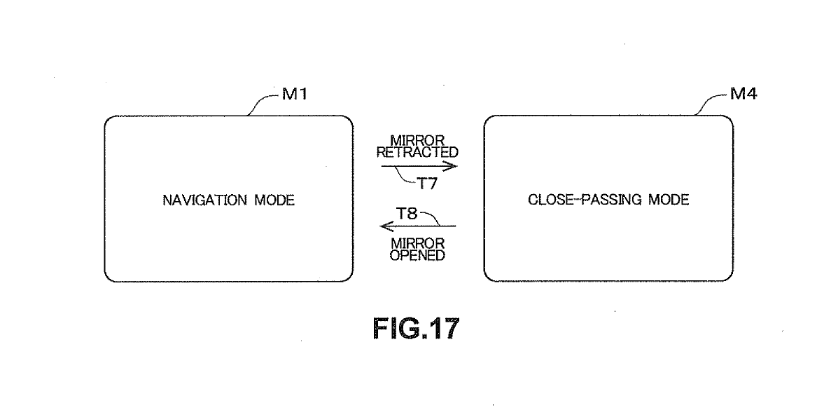

FIG. 17 shows operation-mode transition on the image display system 120 of the third embodiment. The image display system 120 of the third embodiment includes a navigation mode M1, a front mode M2 and a back mode M3, and further includes a close-passing mode M4, as operation modes. In the third embodiment as well, the navigation mode M1, the front mode M2 and the back mode M3 are switched in the same manner as the transition of the first embodiment (refer to FIG. 5).

In the third embodiment, when the side-mirror 93 is retracted under the situation where the operation mode is the navigation mode M1, the operation mode is switched to the close-passing mode M4 (arrow T7). When the side-mirror 93 is opened under the situation where the operation mode is the close-passing mode M4, the operation mode is switched back to the navigation mode M1 (arrow T8). Moreover, when the side-mirror 93 is retracted under the situation where the operation mode is the front mode M2 or the back mode M3, the operation mode may be switched to the close-passing mode M4.

The close-passing mode M4 provides a useful display image when the vehicle 9 runs in the case where the side surface of the vehicle 9 is close to an object. At the time when the side surface of the vehicle 9 is close to an object, the user needs to check the clearance between the side surface of the vehicle 9 and the object. However, it is difficult for the user to directly check the side areas of the vehicle 9, especially the side area on the opposite side to a driver seat. Therefore, the close-passing mode M4 provides the display image that shows the side areas of the vehicle 9.

In the close-passing mode M4, a display image generator 32 of an image generator 3 generates a display image that shows the side areas, each of which also covers the area in the traveling direction of the vehicle 9 based on the shot images acquired by a left-side camera 53 and a right-side camera 54. Then, the generated display image is displayed on a display 21. Therefore, in the close-passing mode M4, the display images are displayed in different forms in accordance with the traveling direction of the vehicle 9.

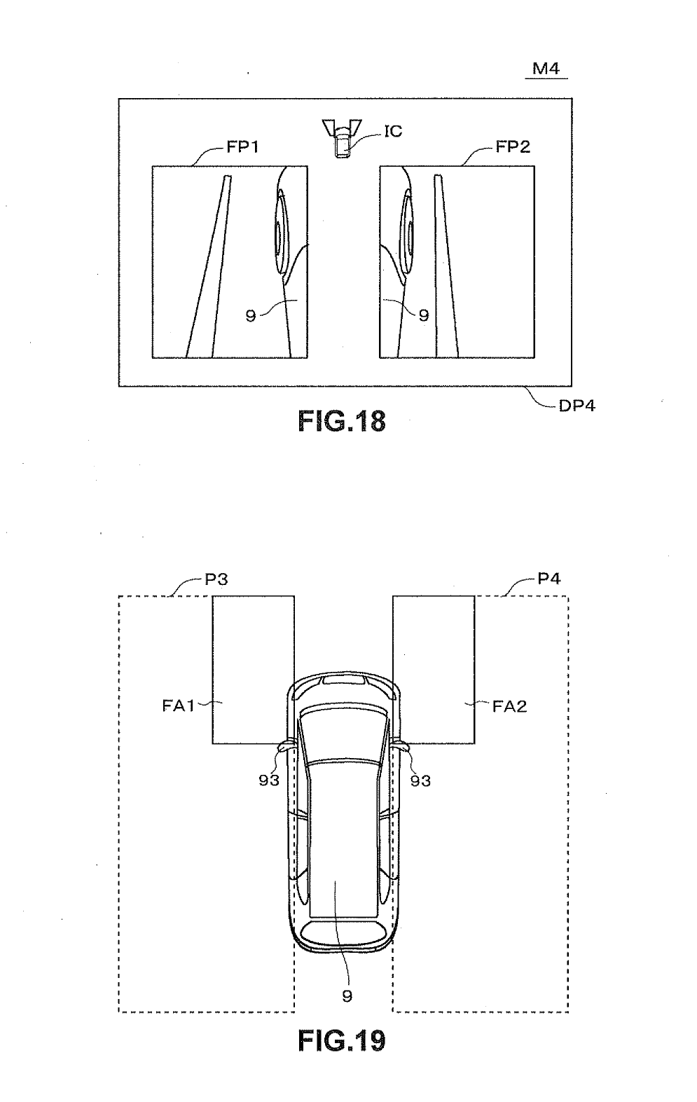

FIG. 18 shows an example of a display image DP4 in the close-passing mode M4 when the traveling direction of the vehicle 9 is the forward direction. The display image DP4 includes two side images of a left-side image FP1 and a right-side image FP2, and an icon IC, which are placed side by side. The icon IC shows in symbolic form the periphery of the vehicle 9 shown in the side images FP1 and FP2.

The left-side image FP1 shows the left-side area of the vehicle 9 which covers the area in front of the vehicle 9 in the traveling direction. Concretely, the left-side image FP1 shows the area anterior to the side-mirror 93 that is mounted on the left side of the vehicle 9. The left-side image FP1 also includes an image of a body near a left-front tire of the vehicle 9.

On the other hand, the right-side image FP2 shows the right-side area of the vehicle 9 which covers the area in front of the vehicle 9 in the traveling direction. Concretely, the right-side image FP2 shows the area anterior to the side-mirror 93 that is mounted on the right side of the vehicle 9. The right-side image FP2 also includes an image of a body near a right-front tire of the vehicle 9.

FIG. 19 describes a method for generating the side images FP1 and FP2 that are included in the display image DP4. The left-side image FP1 is generated based on an area FA1 that is clipped from a shot image P3 acquired by the left-side camera 53. The area FA1 includes the part anterior to the side-mirror 93 and closer to the vehicle 9 (right-side part in the shot image P3 of FIG. 19). On the other hand, the right-side image FP2 is generated based on an area FA2 that is clipped from a shot image P4 acquired by the right-side camera 54. The area FA2 includes the part anterior to the side-mirror 93 and closer to the vehicle 9 (left-side part in the shot image P4 of FIG. 19).

In the display image DP4 shown in FIG. 18, the user can notice an object forward that exists in the side areas of the vehicle 9, each of which also covers the area in the traveling direction of the vehicle 9. Moreover, since each of the side images FP1 and FP2 in the display image DP4 includes the image of a part of the body of the vehicle 9, the user can understand the clearance between the vehicle body of the vehicle 9 and an object. Therefore, the user can easily prevent the vehicle 9 from having a collision with the object when the user drives the vehicle 9 forward in the case where the side surface of the vehicle 9 is close to the object.

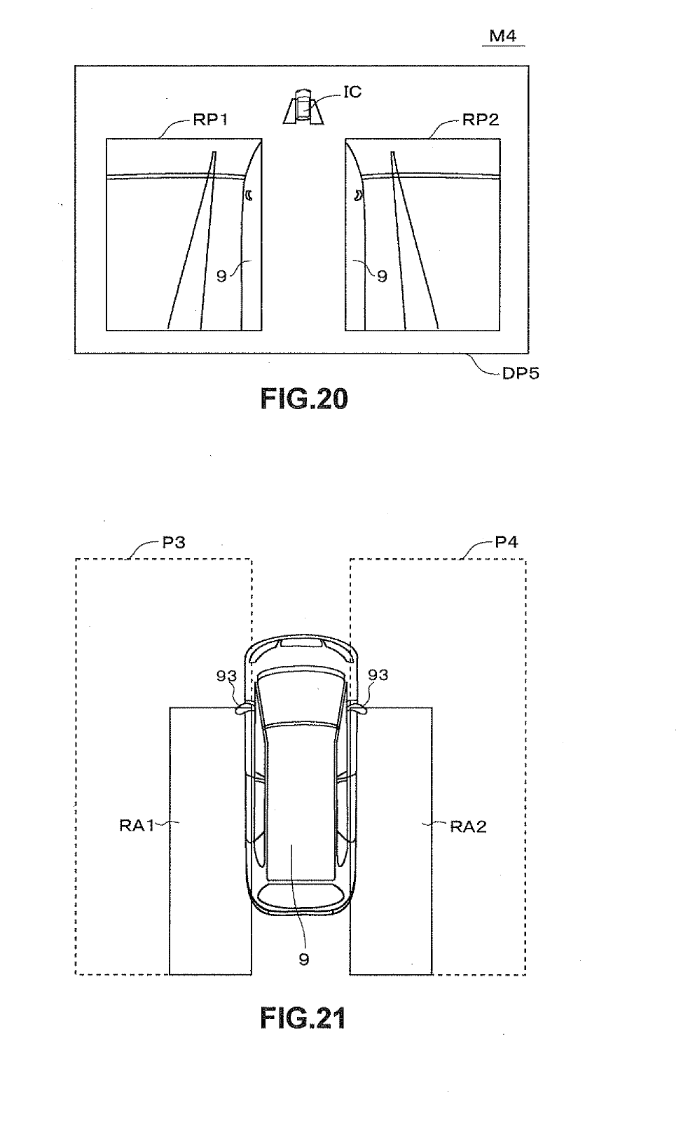

FIG. 20 shows an example of a display image DP5 in the close-passing mode M4 when the traveling direction of the vehicle 9 is the backward direction. The display image DP5 includes two side images of a left-side image RP1 and a right-side image RP2, and the icon IC which are placed side by side. The icon IC shows in symbolic form the periphery of the vehicle 9 shown in the side images RP1 and RP2.

The left-side image RP1 shows the left-side area of the vehicle 9 which covers the area behind the vehicle 9 in the traveling direction. Concretely, the left-side image RP1 shows the area posterior to the side-mirror 93 that is mounted on the left side of the vehicle 9. The left-side image RP1 also includes an image of a body near a left-rear tire of the vehicle 9.

On the other hand, the right-side image RP2 shows the right-side area of the vehicle 9 which covers the area behind the vehicle 9 in the traveling direction. Concretely, the right-side image RP2 shows the area posterior to the side-mirror 93 that is mounted on the right side of the vehicle 9. The right-side image RP2 also partially includes the vehicle image near a right-rear tire of the vehicle 9.

FIG. 21 describes a method for generating the side images RP1 and RP2 that are included in the display image DP5. The left-side image RP1 is generated based on an area RA1 that is clipped from the shot image P3 acquired by the left-side camera 53. The area RA1 includes the part posterior to the side-mirror 93 and closer to the vehicle 9 (right-side part in the shot image P3 of FIG. 21). On the other hand, the right-side image RP2 is generated based on an area RA2 that is clipped from the shot image P4 acquired by the right-side camera 54. The RP2 includes the part posterior to the side-mirror 93 and closer to the vehicle 9 (left-side part in the shot image P4 of FIG. 21).

In the display image DP5 shown in FIG. 20, the user can notice an object backward that exists in the side areas of the vehicle 9, each of which also covers the area in the traveling direction of the vehicle 9. Moreover, since each of the side images RN and RP 2 in the display image DP5 includes the image of a part of the body of the vehicle 9, the user can understand the clearance between the vehicle body of the vehicle 9 and the object. Therefore, the user can easily prevent the vehicle 9 from having a collision with the object when the user drives the vehicle 9 backward in the case where the side surface of the vehicle 9 is close to the object.

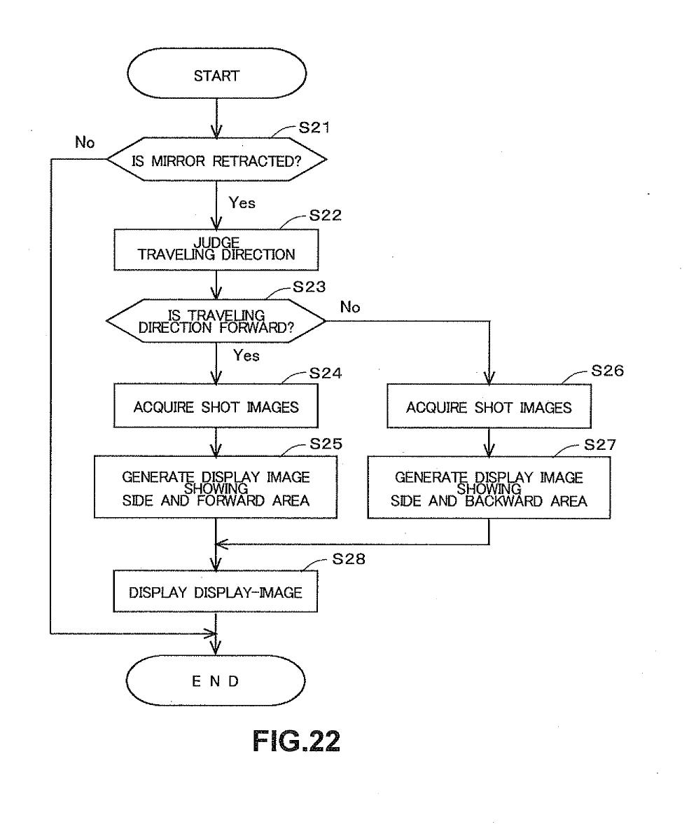

FIG. 22 shows a processing flow in the close-passing mode M4 on the image display system 120. After the operation mode is switched to the close-passing mode M4 in reaction to the side-mirror 93 being retracted, the processing is repeated at a prescribed interval (e.g. 1/30 second).

First, the mirror detector 13 detects the state (retracted or opened) of the side-mirror 93 based on the signal transmitted from the mirror driver 72. When the side-mirror 93 is opened (No at a step S21), the processing in the close-passing mode M4 ends.

When the side-mirror 93 is retracted (Yes at the step S21), next, the shift determining part 12 determines the current shift lever position based on the signal transmitted from a shift position sensor 71. That is, the shift determining part 12 substantially determines the current traveling direction of the vehicle 9 (step S22).

When the traveling direction of the vehicle 9 is the forward direction (that is, when the shift lever is set at a position except “R”) (Yes at a step 23), first, an image acquisition part 41 acquires two shot images from each of the left-side camera 53 and the right-side camera 54 (step S24).

Next, the display image generator 32 generates the display image DP4 that shows the side areas, each of which covers the area in front of the vehicle 9 by use of the shot images through the method described based on FIG. 19 (step S25). The display image DP4 generated as above is transmitted from a navigation communicator 42 to a navigation apparatus 20. Then, the display image DP4 is displayed on the display 21 of the navigation apparatus 20 (step S28).

When the traveling direction of the vehicle 9 is the backward direction (that is, when the shift lever is set at “R”) (No at the step S23), first, the image acquisition part 41 acquires two shot images from each of the left-side camera 53 and the right-side camera 54 (step S26).

Next, the display image generator 32 generates the display image DP5 that shows the side areas, each of which covers the area behind the vehicle 9 by use of the shot images through the method described based on FIG. 21 (step S27). The display image DP5 generated as above is transmitted from the navigation communicator 42 to the navigation apparatus 20. Then, the display image DP5 is displayed on the display 21 of the navigation apparatus 20 (step S28).

As described above, when the side-mirror 93 is retracted, the image display system 120 of the third embodiment generates the display image that shows the side areas, each of which covers the area in the traveling direction of the vehicle 9, and displays the generated display image on the display 21. This allows the user to easily check the states of the side areas of the vehicle 9 in the case where the side surface of the vehicle 9 is close to the object, which are normally difficult for the user to check.

### 4. Modification

So far, the embodiments of the invention are described. However, the invention is not to be considered limited to the described embodiments above, but includes various modifications. Hereafter, these modifications are described. Every embodiment described above and below can be arbitrarily combined with others.

In the first embodiment, the peripheral area A1 shown in the composite image CPI in the front mode M2 and the peripheral area A1 shown in the composite image CP2 in the back mode M3 are identical. However, they are not necessary to be identical.

In the third embodiment, the display image shows the both of the left-side area and the right-side area of the vehicle 9. However, the display image may show one of the left-side area and the right-side area of the vehicle 9. In this case, it is preferable for the display image to show the side area on the opposite side of a driver seat because it is difficult for the user to check the side area.

In the above descriptions of the embodiments, the main body 10 of the image generation apparatus 100 and the navigation apparatus 20 are individually set up. However, one apparatus may include and integrate the main body 10 and the navigation apparatus 20 inside.

In the above descriptions of the embodiments, the navigation apparatus 20 displays the image generated by the image generation apparatus 100. However, the generated image may be displayed on a general display apparatus that has no special function such as the navigation function.

In the above descriptions of the embodiments, a part of the functions implemented by the controller 1 of the image generation apparatus 100 may be implemented by the controller 23 of the navigation apparatus 20.

Moreover, the signal transmitted from the shift position sensor 71 or the mirror driver 72 may be received by the navigation apparatus 20. In this case, the signal can be transmitted to the controller 1 of the image generation apparatus 100 via the navigation communicator 42.

In the above descriptions of the embodiments, various functions are implemented by software, specifically by CPU processing based on programs. However, some of these functions may be implemented by electrical hardware circuits. Contrarily, some of the functions implemented by hardware circuits in the above descriptions may be implemented by software.

While the invention has been shown and described in detail, the foregoing description is in all aspects illustrative and not restrictive. It is therefore understood that numerous other modifications and variations can be devised without departing from the scope of the invention.

What is claimed is:

1. An image generation apparatus that is used in a vehicle and generates an image that shows a periphery of the vehicle, the image generation apparatus comprising:
an input that acquires shot images from a plurality of cameras, each of which captures the periphery of the vehicle in a different direction;
a controller that determines a traveling direction of the vehicle;
a generator that generates a composite image including a first area and a second area in a seamless manner based on the shot images, the first area showing the periphery of the vehicle viewed from a virtual viewpoint that is set looking down at the vehicle, the second area showing an area that includes an outside of the first area and is in a direction opposite to the determined traveling direction; and
an output that transmits a display image including the composite image to a display apparatus to display the display image on the display apparatus.

2. The image generation apparatus of claim 1, wherein
the display image includes the composite image and an image that shows a third area in the determined traveling direction of the vehicle.

3. The image generation apparatus of claim 1, wherein
the composite image includes an image of the vehicle.

4. The image generation apparatus of claim 3, wherein the generator sets,
when the determined traveling direction is a forward direction, a center position of the image of the vehicle in the composite image above a center line that is set horizontally at a vertical center of the composite image, and
when the determined traveling direction is a backward direction, the center position of the image of the vehicle in the composite image below the center line that is set horizontally at the vertical center of the composite image.

5. The image generation apparatus of claim 1, wherein
the generator generates the composite image by projecting data of the shot images onto a virtual projection surface, and
a part corresponding to the first area on the virtual projection surface is a flat surface.

6. The image generation apparatus of claim 5, wherein
a part corresponding to the second area on the virtual projection surface is a curved surface that is contiguous with the flat surface.

7. An image generation apparatus that is used in a vehicle and generates an image that shows a periphery of the vehicle, the image generation apparatus comprising:
an input that acquires shot images from a plurality of cameras, each of which captures one of an area in front of the vehicle and an area behind the vehicle;
a controller that determines a traveling direction of the vehicle;
a generator that generates a display image based on the shot images; and
an output that transmits the display image to a display apparatus to display the display image on the display apparatus, wherein
the generator generates as the display image,
a first display image that shows the area in front of the vehicle when the determined traveling direction of the vehicle is a forward direction, and
selectively one of a second display image and a third display image in conformity with a user's operation when the determined traveling direction of the vehicle is a backward direction, the second display image showing the area behind the vehicle, the third display image showing the area in front of the vehicle in a different form than the first display image.

8. The image generation apparatus of claim 7, wherein
the first display image includes a mask area that partially hides the area in front of the vehicle, and
the third display image does not include the mask area.

9. The image generation apparatus of claim 7, wherein
the first display image includes a non-transparent mask area that partially hides the area in front of the vehicle, and
the third display image includes a transparent mask area that partially hides the area in front of the vehicle.

10. The image generation apparatus of claim 7, wherein
a mask area shown on the first display image is different in shape from a mask area shown on the third display image, each of the mask areas hiding the area in front of the vehicle.

11. An image generation apparatus that is used in a vehicle and generates an image that shows a periphery of the vehicle, the image generation apparatus comprising:
an input that acquires a shot image from a side camera that captures a side area of the vehicle;
a controller that determines a traveling direction of the vehicle;
a detector that detects a state of a side mirror of the vehicle;
a generator that generates a display image that shows the side area covering the determined traveling direction of the vehicle based on the shot image acquired from the side camera, when the side mirror is retracted; and
an output that transmits the display image to a display apparatus to display the display image on the display apparatus.

12. The image generation apparatus of claim 11, wherein
the display image includes an image of a part of a body of the vehicle.

13. An image generation method for use in a vehicle and for generating an image that shows a periphery of the vehicle, the image generation method comprising the steps of:
(a) acquiring shot images from a plurality of cameras, each of which captures the periphery of the vehicle in a different direction;
(b) determining a traveling direction of the vehicle;
(c) generating a composite image that shows a first area and a second area in a seamless manner based on the shot images, the first area showing the periphery of the vehicle viewed from a virtual viewpoint that is set looking down at the vehicle, the second area showing an area that includes an outside of the first area of the vehicle and is in a direction opposite to the determined traveling direction; and
(d) displaying a display image that includes the composite image.

14. An image generation method for use in a vehicle and for generating an image that shows a periphery of the vehicle, the image generation method comprising the steps of:
(a) acquiring shot images from a plurality of cameras, each of which captures one of an area in front of the vehicle and an area behind the vehicle;
(b) determining a traveling direction of the vehicle;
(c) generating a display image based on the shot images; and
(d) displaying the display image, wherein
the step (c) generates as the display image,
a first display image that shows the area in front of the vehicle when the determined traveling direction of the vehicle is a forward direction, and
selectively one of a second display image and a third display image in conformity with a user's operation when the determined traveling direction of the vehicle is a backward direction, the second display image showing the area behind the vehicle, the third display image showing the area in front of the vehicle in a different form than the first display image.

15. An image generation method for use in a vehicle and for generating an image that shows a periphery of the vehicle, the image generation method comprising the steps of:
(a) acquiring a shot image from a side camera that captures a side area of the vehicle;
(b) determining a traveling direction of the vehicle;
(c) detecting a state of a side mirror of the vehicle;
(d) generating a display image that shows the side area covering the determined traveling direction of the vehicle based on the shot image acquired from the side camera when the side mirror is retracted; and
(e) displaying the display image.
